(19) United States
(12) Patent Application Publication
(10) Pub. No.: US 2017/0159738 A1
(43) Pub. Date: Jun. 8, 2017

(54) FLEXIBLE WET FRICTION MATERIALS INCLUDING SILANE

(71) Applicant: Schaeffler Technologies AG & Co. KG, Herzogenaurach (DE)

(72) Inventors: Rashid Farahati, Copley, OH (US); Zhiru Shi, Wooster, OH (US); Murat Bakan, Puebla (MX); Babak LotfizadehDehkordi, Copley, OH (US)

(73) Assignee: Schaeffler Technologies AG & Co. KG, Herzogenaurach (DE)

(21) Appl. No.: 15/367,308

(22) Filed: Dec. 2, 2016

Related U.S. Application Data
(60) Provisional application No. 62/263,072, filed on Dec. 4, 2015.

(51) Int. Cl. F16D 69/02; F16H 45/02

(52) U.S. Cl. CPC F16D 69/026; F16H 45/02; F16D 2200/0082; F16D 2200/006; F16D 13/40

(57) ABSTRACT

A friction material for a clutch comprising: a plurality of fibers; a filler material: and, a binder including at least 3% and at most 50% silane by weight based on total weight of the binder. The friction material is devoid of added water. In an example aspect, the silane is an organosilane having a reactive organic ureido group and a hydrolyzable inorganic triethoxysilyl group. In an example aspect, the binder further includes phenolic resin, wherein the phenolic resin forms byproduct water upon curing to react with the hydrolyzable inorganic triethoxysilyl group to form a cross-linked binder. A method forming a hybrid matrix composite for a flexible clutch friction material is also disclosed.

### FIELD

The present disclosure relates generally to a wet friction material for clutch pads, in particular, a flexible wet friction material having higher performance characteristics.

### BACKGROUND

Known friction material for clutches is composed of fiber material and filler material. The fiber material forms the structure of the friction material and the filler material creates friction. Known friction material further includes a binder such as phenolic resin. It is desirable to increase both static and dynamic friction coefficients for friction material. It is particularly desirable to increase the dynamic friction coefficient.

### BRIEF SUMMARY

Example aspects broadly comprise a friction material for a clutch comprising: a plurality of fibers; a filler material: and, a binder including at least 3% and at most 50% silane by weight based on total weight of the binder. In an example aspect, the friction material is devoid of added water. In an example aspect, the silane is an ureidofunctional silane. In an example aspect, the ureidofunctional silane is devoid of ethylcarbamate. In an example aspect, the silane is an organosilane having a reactive organic ureido group and a hydrolyzable inorganic triethoxysilyl group. In an example aspect, the binder further includes a phenolic resin. In an example aspect, the binder includes at least 50% and at most 97% phenolic resin by weight based on total weight of the binder. In an example aspect, the phenolic resin forms byproduct water as a result of a reaction between a phenol and a formaldehyde upon curing. In an example aspect, the hydrolyzable inorganic triethoxysilyl group is hydrolyzed with the byproduct water to form a cross-linked binder. In an example aspect, the plurality of fibers are selected from the group consisting of cellulose fibers, aramid fibers, cotton fibers, carbon fibers, or a combination thereof. In an example aspect, the filler material is a silica-rich, inorganic filler. In an example aspect, the silica-rich, inorganic filler is diatomaceous earth.

Other example aspects broadly comprise a torque converter comprising: a clutch; and, the friction material as described above.

Other example aspects broadly comprise a hybrid matrix composite for a clutch friction material comprising: a plurality of fibers; a plurality of filler particles; a binder including: at least 3% and at most 50% silane by weight based on total weight of the binder; at least 50% and at most 97% phenolic resin by weight based on total weight of the binder; and, devoid of added water. In an example aspect, the silane is an organosilane having a reactive organic ureido group and a hydrolyzable inorganic triethoxysilyl group. In an example aspect, the phenolic resin forms byproduct water upon curing to react with the hydrolyzable inorganic triethoxysilyl group to form a cross-linked binder.

Other example aspects broadly comprise a method for forming a hybrid matrix composite for a flexible friction material, the method comprising: mixing a plurality of fibers and a plurality of filler particles to form a substrate; mixing at least 3% and at most 50% silane by weight based on total weight of the binder and at least 50% and at most 97% phenolic resin by weight based on total weight of the binder to form a binder solution, wherein the binder solution is devoid of added water; saturating the substrate with the binder solution to form a uniformly impregnated matrix; and, curing the matrix to form a flexible friction material. In an example aspect, the silane is an organosilane having a reactive organic ureido group and a hydrolyzable inorganic triethoxysilyl group. In an example aspect, the step of curing includes the phenolic resin forming a byproduct water as a result of a reaction between a phenol and a formaldehyde; and wherein the step of curing further includes the byproduct water reacting with the hydrolyzable inorganic triethoxysilyl group to form a cross-linked binder. In an example aspect, the step of curing the matrix includes curing at a temperature from at least 100 to at most 175° C.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic cross-sectional view of friction material including silane according to an example aspect;

FIG. 2 is a schematic cross-sectional view of friction material including silane according to an example aspect; and,

FIG. 3 is a cross-sectional view of a torque converter having friction material according to an example aspect; and,

FIG. 4A is a graph plotting respective friction coefficients versus speed for known friction material and FIG. 4B is a graph plotting respective friction coefficients versus speed for friction material including silane.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. Although any methods, devices or materials similar or equivalent to those described herein can be used in the practice or testing of the invention, the following example methods, devices, and materials are now described.

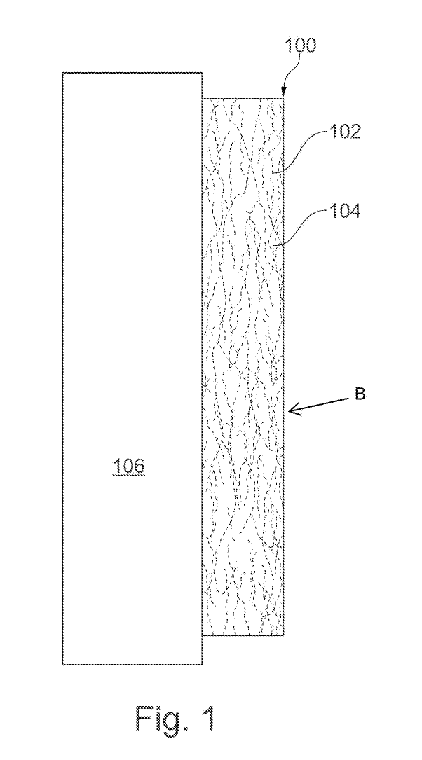

The following description is made with reference to FIGS. 1-4.

In an example aspect, a friction material for a clutch comprises a plurality of fibers and a filler material. FIG. 1 is a schematic cross-sectional view of friction material 100. Friction material 100 can be used on any clutch plate 106 known in the art. In an example embodiment, friction material is fixedly secured to plate 106. Friction material 100 includes fiber material 102 and filler material 104. Friction material 100 further includes binder B, such as phenolic resin or latex, saturating fibers 102 and filler 104. Fiber material 102 can be any organic or inorganic fiber known in the art, for example including but not limited to cellulose, aramid, cotton, or carbon fibers. In an example aspect, filler material 104 includes at least one silica-containing material. Filler material 104 is also refereed to interchangeably herein as filler particles 104. Any silica-containing material known in the art can be used. In an example embodiment, the silica-containing material includes, but is not limited to: Celite®, Celatom®, diatomaceous earth or silicon dioxide. Typically diatomaceous earth is inorganic and amorphous.

Generally, friction materials used for clutches or more particularly for torque converter clutches are disposed between two opposing plates. To compensate for plates, which are typically not perfectly parallel and/or flat due to taper or run-out as is known in the art, a flexible friction material is desired in order to enable maximum contact between the friction material and the reaction plate(s). Friction material that is too stiff limits contact with the plate(s) disadvantageously and leads to poor performance and/or durability issues. Typically, binder B of friction material 100 includes a phenolic resin as known in the art. Phenolic resin upon curing forms water as a byproduct of a reaction between a phenol and a formaldehyde. In an example aspect, non-limiting example Arofene® 295-E-50 is useful as impregnating resin for friction paper. To increase the flexibility for wet friction materials, in an example aspect, phenolic resin is at least partially replaced by silane as a binder component for a wet friction material.

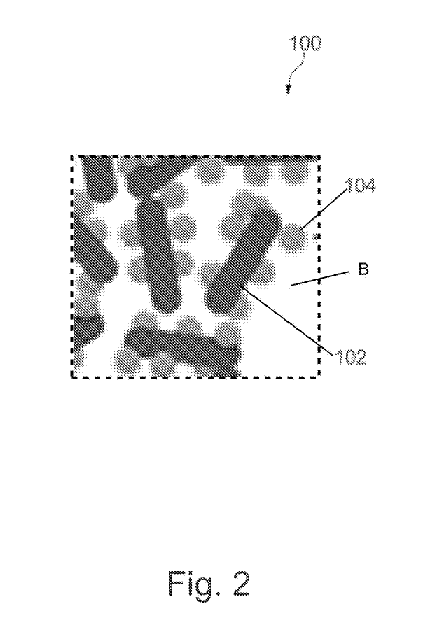

FIG. 2 is a schematic cross-sectional view of friction material including silane according to an example aspect showing a hybrid composite matrix including inorganic or organic fibers 102, filler material 104, and binder B distributed, saturating, and/or impregnating the fibers and filler. In an example aspect, binder B comprises a phenolic resin and a silane. Silanes are monomeric silicon compounds with four substituent groups attached to the silicon atom. These substituent groups can be nearly any combination of nonreactive, inorganically reactive, or organically reactive groups. Inorganic reactivity represents the covalent bonds formed through oxygen to the silicon atom to form a siloxane type of bond. Organic reactivity occurs on the organic portion of the molecule and does not directly involve the silicon atom. Silanes are useful in numerous applications as adhesion promoters, crosslinking agents, water scavengers, and/or coupling agents.

In an example aspect, the silane is an ureidofunctional silane. Advantageously, the ureidofunctional silane is devoid of carcinogenic ethylcarbamate. In an example aspect, the silane is an organosilane having a reactive organic ureido group and a hydrolyzable inorganic triethoxysilyl group. In an example aspect, the binder composition for friction materials including phenolic resin and silane is devoid of added water. In an example aspect, water is formed as a byproduct in the reaction between a phenol and a formaldehyde in the phenolic resin. The byproduct water then hydrolyzes with the hydrolyzable inorganic triethoxysilyl group of the silane to provide cross-linking. The resulting friction material including binder of phenolic resin and silane is more flexible as compared with friction material made with only phenolic resin binder. The curative process for phenolic resin containing silane additions may vary according to sample size and environmental conditions, for example. For laboratory samples as discussed herein, typical curing times and temperatures for friction materials including silane-containing binders includes at least 4 minutes at 175° C.; however, curing up to 10 minutes 100° C. and up to 10 minutes 175° C. consecutively may be required.

In an example aspect, binder B includes from about 3% to about 50% by weight silane based on total weight of the binder. In an example aspect, binder B includes at least 3% by weight silane and at most 50% by weight silane based on total weight of the binder. In an example aspect, binder B includes at least 5% by weight silane and at most 40% by weight silane based on total weight of the binder. In an example aspect, binder B includes at least 5% by weight silane and at most 25% by weight silane based on total weight of the binder. In an example aspect, binder B includes at least 5% by weight silane and at most 15% by weight silane based on total weight of the binder. In an example aspect, binder B includes about 10% by weight silane.

In an example aspect, and in view of FIGS. 1 and 2, the friction material is also referred to interchangeably herein as a hybrid matrix composite for a flexible clutch friction material. the hybrid matrix composite 100 comprises a plurality of fibers 102; a plurality of filler particles 104, and binder B including: at least 3% and at most 50% silane by weight based on total weight of the binder; at least 50% and at most 97% phenolic resin by weight based on total weight of the binder; and, devoid of added water. In an example aspect, the silane is an organosilane having a reactive organic ureido group and a hydrolyzable inorganic triethoxysilyl group. In an example aspect, the phenolic resin forms byproduct water upon curing to react with the hydrolyzable inorganic triethoxysilyl group to form a cross-linked binder.

In an example aspect, friction material 100 includes at most 17% by weight silane based on total weight of friction material. Wherein an example formulation for friction material includes approximately equal amounts by weight of fiber, filler, and resin components, the silane content in the friction material is in a range from about 1% to about 17% by weight based on the total weight of the friction material. A suitable amount of silane is at least 1% to at most 17% by weight based on the total weight of the friction material in an example aspect; at least 2% to at most 15% in another example aspect, at least 2% to at most 10% in another example aspect, at least 4% to at most 8% in another example aspect, and at least 5% to at most 7% in another example aspect.

In an example aspect, a method for forming a hybrid matrix composite for a flexible friction material 100 is described. The method comprises at least the steps as follows: (i) mixing a plurality of fibers 102 and a plurality of filler particles 104 to form a substrate; (ii) mixing at least 3% and at most 50% silane by weight based on total weight of the binder and at least 50% and at most 97% phenolic resin by weight based on total weight of the binder to form a binder solution, wherein the binder solution is devoid of added water; (iii) saturating the substrate with the binder solution to form a uniformly impregnated matrix; and, (iv) curing the matrix to form a flexible friction material. In an example aspect, the silane is an organosilane having a reactive organic ureido group and a hydrolyzable inorganic triethoxysilyl group. In an example aspect, step of curing includes the phenolic resin forming a byproduct water as a result of a reaction between a phenol and a formaldehyde; and wherein the step of curing further includes the byproduct water reacting with the hydrolyzable inorganic triethoxysilyl group to form a cross-linked binder. In an example aspect, the step of curing the matrix includes curing at a temperature from at least 100 to at most 175° C.

Example 1: known friction material includes 45 percent filler material and 55 percent fiber material. The fiber material includes 40 percent cellulose fiber, 10 percent aramid fibers, and 5 percent carbon fibers. The binder is 100% phenolic resin for saturating/impregnating the friction material and cured for 4 minutes at 175° C. Percentages are by weight. The filler is 100% diatomaceous earth as is known in the art.

Example 2: friction material 100 includes 45 percent filler material and 55 percent fiber material. The fiber material includes 40 percent cellulose fiber, 10 percent aramid fibers, and 5 percent carbon fibers. The binder for Example 2 includes 10% silane. The binder is a phenolic resin solution having 90 parts by weight solid content and silane having 10 parts by weight solid content. The phenolic resin and silane are mixed to achieve a homogenous solution prior to saturating/impregnating the friction material. No water is added before or during the saturation because, without being bound by theory, it is believed that water additions disadvantageously may lead to the start of gelation (crosslinking) reactions of the silane. Hydrolysis of the silane occurs during resin cure due to the formation of water as a byproduct as a result of the reaction between phenol and formaldehyde of phenolic resin. Therefore, the self-crosslinking of silane is suppressed until it is finely distributed, saturated, and impregnating inside to form an evenly distributed friction material hybrid composite matrix. Friction material 100 containing silane requires longer curing times, for example, Example 2 is cured at for 10 minutes at 100° C. and 10 minutes at 175° C. consecutively. Percentages are by weight. The filler for Example 2 is 100% diatomaceous earth; however, other inorganic, silica-containing filler materials as are known in the art may be used in the concept of this invention.

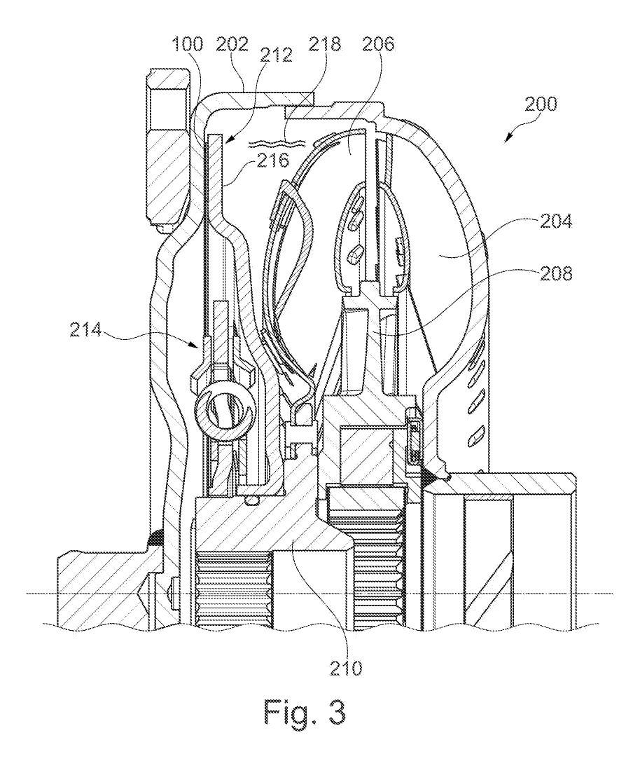

FIG. 3 is a partial cross-sectional view of example torque converter 200 including friction material 100 shown in FIG. 1. Torque converter 200 includes cover 202, impeller 204 connected to the cover, turbine 206 in fluid communication with the impeller, stator 208, output hub 210 arranged to non-rotatably connect to an input shaft (not shown) for a transmission, torque converter clutch 212, and vibration damper 214. Clutch 212 includes friction material 100 and piston 216. As is known in the art, piston 216 is displaceable to engage friction material 100 with piston 216 and cover 202 to transmit torque from cover 202 to output hub 210 through friction material 100 and piston 216. Fluid 218 is used to operate clutch 212.

Although a particular example configuration of torque converter 200 is shown in FIG. 3, it should be understood that the use of friction material 100 in a torque converter is not limited to a torque converter as configured in FIG. 3. That is, material 100 is usable in any clutch device, using friction material, for any torque converter configuration known in the art.

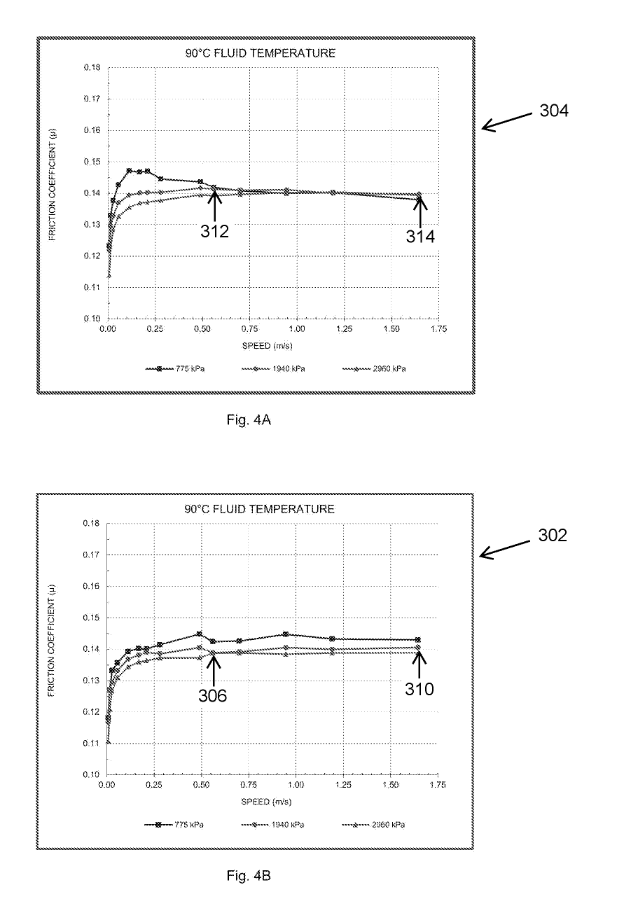

FIGS. 4A and 4B are graphs plotting respective friction coefficients versus speed for known friction material as shown in FIG. 4A and friction material 100 as formulated in Example 2 above as shown in FIG. 4B. The speed in the x direction of the graph is the speed of the friction material with respect to a plate with which the friction material is in contact with. For example, the speed is the slip speed between the friction material and the plate. Plot 302 is for material 100 as formulated in Example 2 above wherein the binder material includes 10% silane by weight relative to total weight of the binder material. Plot 304 is for a known friction material including 100% phenolic resin binder as in Example 1 above. Plots 302 and 304 are based on actual tests of the known friction material and friction material 100 at 90° C. and 775, 1940, and 2960 kPa as shown in key. As noted above, it is desirable to maximize both static and dynamic friction for friction material for a clutch.

Generally, material 100 and known material have similar static friction coefficients. Regarding the dynamic friction coefficient, advantageously, the friction coefficient at 1940 kPa, for example, for plot 302 continues to increase from point 306 at 0.56 m/s to point 310 at approximately 1.70 m/s, where the value increases from 0.139 to 0.141μ. In contrast, the friction coefficient for plot 304 flattens or decreases between point 312 at 0.56 m/s and point 314 at approximately 1.70 m/s, where the value decreases from 0.141 to 0.138.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A friction material for a clutch comprising:
a plurality of fibers;
a filler material: and,
a binder including at least 3% and at most 50% silane by weight based on total weight of the binder.

2. The friction material of claim 1 is devoid of added water.

3. The friction material of claim 1, wherein the silane is an ureidofunctional silane.

4. The friction material of claim 2, wherein the ureidofunctional silane is devoid of ethylcarbamate.

5. The friction material of claim 1, wherein the silane is an organosilane having a reactive organic ureido group and a hydrolyzable inorganic triethoxysilyl group.

6. The friction material of claim 5, wherein the binder further includes a phenolic resin.

7. The friction material of claim 6, wherein the binder includes at least 50% and at most 97% phenolic resin by weight based on total weight of the binder.

8. The friction material of claim 6, wherein the phenolic resin forms byproduct water as a result of a reaction between a phenol and a formaldehyde upon curing.

9. The friction material of claim 8, wherein the hydrolyzable inorganic triethoxysilyl group is hydrolyzed with the byproduct water to form a cross-linked binder.

10. The friction material of claim 1, wherein the plurality of fibers are selected from the group consisting of cellulose fibers, aramid fibers, cotton fibers, carbon fibers, or a combination thereof.

11. The friction material of claim 1, wherein the filler material is a silica-rich, inorganic filler.

12. The friction material of claim 11, wherein the silica-rich, inorganic filler is diatomaceous earth.

13. A torque converter comprising:
a clutch; and,
the friction material of claim 1.

14. A hybrid matrix composite for a clutch friction material comprising:
a plurality of fibers;
a plurality of filler particles;
a binder including:
at least 3% and at most 50% silane by weight based on total weight of the binder;
at least 50% and at most 97% phenolic resin by weight based on total weight of the binder; and,
devoid of added water.

15. The hybrid matrix composite of claim 14, wherein the silane is an organosilane having a reactive organic ureido group and a hydrolyzable inorganic triethoxysilyl group.

16. The hybrid matrix composite of claim 15, wherein the phenolic resin forms byproduct water upon curing to react with the hydrolyzable inorganic triethoxysilyl group to form a cross-linked binder.

17. A method for forming a hybrid matrix composite for a flexible friction material, the method comprising:
mixing a plurality of fibers and a plurality of filler particles to form a substrate;
mixing at least 3% and at most 50% silane by weight based on total weight of the binder and at least 50% and at most 97% phenolic resin by weight based on total weight of the binder to form a binder solution, wherein the binder solution is devoid of added water;
saturating the substrate with the binder solution to form a uniformly impregnated matrix; and,
curing the matrix to form a flexible friction material.

18. The method of claim 17, wherein the silane is an organosilane having a reactive organic ureido group and a hydrolyzable inorganic triethoxysilyl group.

19. The method of claim 18, wherein the step of curing includes the phenolic resin forming a byproduct water as a result of a reaction between a phenol and a formaldehyde; and wherein the step of curing further includes the byproduct water reacting with the hydrolyzable inorganic triethoxysilyl group to form a cross-linked binder.

20. The method of claim 17, wherein the step of curing the matrix includes curing at a temperature from at least 100 to at most 175° C.
